(19) United States
(12) Patent Application Publication
(10) Pub. No.: US 2005/0171278 A1
(43) Pub. Date: Aug. 4, 2005

(54) Use of a pretreated silica in a silicone composition crosslinkable by polycondensation, as agent for stabilizing moulds obtained from said composition

(76) Inventors: Fabienne Howe, Caluire (FR); Jens Heilman, Singapore (SG)

Correspondence Address: BURNS DOANE SWECKER & MATHIS L L P, POST OFFICE BOX 1404, ALEXANDRIA, VA, 22313-1404, US

(21) Appl. No.: 10/506,207

(22) PCT Filed: Feb. 28, 2003
(86) PCT No.: PCT/FR03/00655

(30) Foreign Application Priority Data
Mar. 1, 2002 (CN) 02123133.8

(51) Int. Cl. C08L 83/04

(52) U.S. Cl. 524/863

(57) ABSTRACT

The present invention relates to the use, for improving the longevity of moulds made of polycondensation-crosslinking silicone elastomer, of an additive capable of stabilizing the silicone elastomer of which the mould is made with respect to materials to be moulded and especially polyester resins. This stabilizer is based on silica pretreated with a silane. It is preferably a ground quartz treated with an alkyl silane.

The present invention relates to the field of polycondensation-crosslinkable silicone elastomer compositions. The polyorganosiloxanes (POSs) under consideration are of the room-temperature vulcanizable (RTV) type, given that, conventionally, they are in the form of two-pack systems (RTV-2).

These products are particularly known for their uses in the field of moulding, in which they are used for manufacturing moulds.

In the context of the present invention, interest is directed more particularly towards silicone elastomer compositions that crosslink by a polycondensation reaction, which have improved sensitivity characteristics compared with the compounds contained in compositions intended to be moulded.

Even more specifically, the present invention is directed towards the use of an optionally treated silicic filler in polycondensation-crosslinkable elastomer silicone compositions so as to reduce the harmful action or the compounds contained in compositions to be moulded and allowing the silicone composition to maintain its mechanical properties.

Silicone compositions of the room-temperature vulcanizable elastomer type advantageously in two-pack form (RTV-2) are particularly suitable for making impressions, reproducing shapes or creating shapes by moulding. This is explained by the fact that these compositions are endowed with melt-flow properties and film-forming properties before crosslinking that allow their use for making impressions, but also for constituting suitable moulds from the impressions, after crosslinking which brings about curing of the silicone elastomer. The good heat resistance of crosslinked RTVs allows moulds made from these materials to withstand the high melting temperatures of certain moulding materials such as metals. Making moulds out of RTV silicone elastomer is particularly advantageous for obtaining small series for which the cost and time of manufacture of the mould are not prohibitive, in contrast with what is observed when the mould is metallic.

However, in certain particular moulding applications, the use of RTV silicone compositions has revealed its limitations. Specifically, it has been found that in the reproduction of figurines made of polyester resins using moulds based on RTV compositions, these moulds show a dramatic drop in their mechanical characteristics and thus their performance qualities in the course of their use. Thus, after 40 or 50 mould-stripping operations, the surface of the mould that is directly in contact with the polyester resin becomes soft and fragile. An analysis of the mould revealed that, in point of fact, the mould had many cracks. This phenomenon is accentuated by the mould-stripping process, during which the mould is subjected to large stresses.

This phenomenon of deterioration of the mould is partly explained, in the case of unsaturated polyester resins, by the penetration of styrene monomers contained in the resins, into the mould. This styrene then partially polymerizes to polystyrene inside the silicone matrix, with formation of an interpenetrating network based on polysiloxane and polystyrene. This is reflected by a deterioration in the elastic and mechanical properties of the mould, and then, after a certain number of mould-stripping operations, by the appearance of microcracks rendering it unusable.

A second phenomenon that is the cause of the faster deterioration of silicone moulds is that manufacturers of moulded parts use inferior-quality resins out of concern for profitability. Thus, these resins comprise a larger proportion of pulverulent tillers and require a significant increase in the crosslinking temperatures of the resins. The moulds are then directly subjected to this temperature increase. The said moulds begin to swell, this swelling then significantly reducing their service life.

The prior art discloses various routes of exploration intended to significantly reduce the harmful action of the solvents contained in moulding resins and thus to increase the service life of the moulds.

Thus, document EP-B-0 404 325 describes a method for improving the service life of silicone elastomer moulds, which consists in depositing on the surface of the mould in contact with an amine-based moulding composition a silane-based protective coat, such as chloropropyltrimethoxysilane. However, the use of such a protective coat is far from providing an optimum solution to the problem generated by the solvents used in moulding compositions. Specifically, the silanes constituting the protective coat are generally in the form of a mixture with a suitable solvent such as isopropyl alcohol. However, it is found that such a solvent causes the silicone elastomer of which the mould is made to swell greatly, in the same way as the solvent contained in the moulding composition. After each application of the protective coat, it is thus necessary to wait until the solvent nas evaporated ott, so as to limit its harmful action. Another drawback relates to the fact that it is necessary to apply a protective coat at each moulding cycle. The reason for this is that some of the protective coat is removed during the moulding operation, by remaining solidly fastened to the moulded part. Besides, because this protective coat can impair the refinishing capacity of the moulded part, a reduction in the moulding quality takes place in the course of the moulding operations, due to the fact that the protective coat, although removed in certain places, remains in others and especially in the corners, accumulating as fresh coats are applied and thus reducing the precision of the moulding operation. Added to these technical problems is, obviously, the problem of increasing the production costs.

Other approaches consisted in increasing the resistance of the mould to the moulding resin, especially by developing optimized formulations of the crosslinkable silicone compositions forming the moulds as regards the polymer/crosslinking agent content, the type and content of filler and the type and content of catalyst.

Thus, document EP-A-0 586 153 describes a crosslinkable silicone composition comprising, in addition to the constituents commonly used in such a composition, reinforcing co-fillers such as acicular filters based on CaO and SiO₂ or CaSiO₃; circular fillers based on ceramics and especially on silica-alumina ceramics.

While it is true that such approaches have afforded a certain amount of improvement in the resistance of moulds made of silicone elastomers with respect to resin-based moulding compositions, they have not, however, made it possible to obtain a satisfactory degree of improvement, especially with regard to the additional costs incurred.

Another approach is described in document EP-B-0 787 766. The said document describes room-temperature condensation-crosslinkable silicone compositions for making moulds, comprising, besides the constituents conventionally used in compositions of this type, additives chosen from the group consisting of sterically hindered phenols, sterically hindered thiobisphenols, zinc dialkyldithiophosphates, zinc diaryldithiophosphates, aromatic amines, sterically hindered amines or preparations based on these compounds. However, in view of the results, it is seen that the additives tested are not particularly convincing in terms of resistance to organic resins, since no significant increase in the service life of the moulds is observed.

In another field of use, mention may be made of document U.S. Pat. No. 5,777,002. The said document describes a method for preparing polyaddition-crosslinkable silicone elastomer compositions comprising a large amount of fillers. This method consists in mixing the constituents of the composition at a temperature below 60° C., for a time that is sufficient to allow the treatment of the quartz and silica, used as fillers in the composition, with a disilazane also contained in the composition. The composition thus obtained has improved characteristics, especially in terms of resistance to degradation with oils, tearing, elongation and traction. Furthermore, it shows better behaviour with respect to swelling. Mixing the constituents at a temperature below 60° C. produces a crosslinkable silicone composition that has improved melt-flow characteristics. Such characteristics thus make it possible to increase the amount of fillers incorporated into the composition. The disilazane used in the composition is preferably hexamethyldisilazane.

Although the said document does indeed describe the treatment of silicic fillers in situ with a disilazane in a crosslinkable silicone composition, it relates only to polyaddition-crosslinkable silicone compositions. Furthermore, the present treatment has the function only to improve the resistance of the composition to oils.

In such a technical context, a main object of the present invention is to propose a polycondensation-crosslinkabie silicone elastomer composition that has improved properties of resistance to the solvents used in moulding compositions.

Another object of the present invention is to propose a polycondensation-crosslinkable silicone elastomer composition for forming moulds whose service life is substantially improved.

Another object of the present invention is to propose a polycondensation-crosslinkable silicone elastomer composition for forming moulds whose mechanical properties are stable over time.

Another object of the present invention is to propose a polycondensation-crosslinkable silicone elastomer composition for forming moulds that show little tendency to swelling.

Another object of the present invention is to propose a polycondensation-crosslinkable silicone elastomer composition for forming moulds, which is also easy to prepare and economical.

The Applicant Company has to its credit demonstrated, entirely surprisingly and unexpectedly, that the use of a stabilizer based on silica pretreated with a silane, in a polycondensation-crosslinkable silicone elastomer composition, allows these objects to be achieved.

The present invention therefore relates to the use of silica pretreated with a silane, in a polycondensation-crosslinkable silicone composition, which is the elastomer precursor for making moulds for polymer materials, as an agent for stabilizing the said elastomer so as to improve the longevity of the said moulds.

Advantageously, the silica used is a ground quartz.

According to one particularly advantageous embodiment, a silane corresponding to the general formula (I) is used:
SiR¹ₐR²_{b} (I)
in which:
R¹ is, independently, a C₁-C₆ and preferably C₁-C₄ saturated or unsaturated alkoxy or a C₁-C₆ and preferably C₁-C₄ saturated or unsaturated alkyl;
R² is, independently, a hydrogen atom or a chlorine atom;
a and b are between 0 and 4, and
a+b is equal to 4.

According to one preferred embodiment, this silane is an alkylsilane. The quartz thus treated is distributed, for example, by the company Silbelco Belgique.

In an entirely preferable manner, the ground and treated quartz used consists of particles with a mean size of 3 μm.

According to one noteworthy characteristic, the polycondensation-crosslinkable silicone composition is of the type of those comprising:
(A) at least one diorganopolysiloxane oil bearing at each end of the chain at least two condensable or hydrolysable groups, or a single hydroxyl group;
(B) optionally at least one silane comprising at least three condensable or hydrolysable groups, when (A) is an oil containing hydroxyl end groups;
(C) optionally a catalytically effective amount of a polycondensation catalyst;
(D) an effective amount of at least one stabilizer as defined above.

Advantageously, the composition may also comprise:
(E) optionally at least one reinforcing and/or semi-reinforcing filler;
(F) optionally at least one other additive or adjuvant.

The diorganopolysiloxane oils (A) that may be used in the compositions according to the invention are more particularly those corresponding to formula (I):
YₙSiR₃₋ₙO (SiR₂O)ₓSiR₃₋ₙYₙ (I)
in which:
R represents identical or different monovalent hydrocarbon-based radicals, Y represents identical or different hydrolysable or condensable groups (other than OH), or hydroxyl groups,
n is chosen from 1, 2 and 3 with n=1 when Y is a hydroxyl, and x is an integer greater than 1, preferably greater than 10.

The viscosity of the oils of formula (I) is between 50 and 106 mPa·s at 25° C.

Examples of radicals R which may be mentioned include alkyl radicals containing from 1 to 8 carbon atoms, such as methyl, ethyl, n-propyl, butyl, hexyl and octyl, vinyl radicals and phenyl radicals.

Examples of substituted radicals R which may be mentioned include 3,3,3-trifluoropropyl, chlorophenyl and β-cyanoethyl radicals.

In the products of formula (I) generally used industrially, at least 60%, preferably at least 80% in numerical terms of the radicals R are methyl radicals, and the other radicals are generally phenyl radicals.

Examples of hydrolysable groups Y which may be mentioned include amino, acylamino, aminoxy, cetiminoxy, iminoxy, enoxy, alkoxy, alkoxy-alkylenoxy, acyloxy and phosphato groups and, for example, among these:
for the amino groups Y: n-butylamino, sec-butylamino and cyclohexylamino groups,
for the N-substituted acylamino groups: the benzoylamino group,
for the aminoxy groups: dimethylaminoxy, diethylaminoxy, dioctylaminoxy and diphenylaminoxy groups,
for the iminoxy and cetiminoxy groups: those derived from acetophenone oxime, acetone oxime, benzophenone oxime, methyl ethyl ketoxime, diisopropyl ketoxime and chlorocyclohexanone oxime,
for the alkoxy groups Y: groups containing from 1 to 8 carbon atoms, such as methoxy, propoxy, isopropoxy, butoxy, hexyloxy and octyloxy groups,
for the alkoxy-alkylenoxy groups Y: the methoxy-ethylenoxy group,
for the acyloxy groups Y: groups containing from 1 to 8 carbon atoms, such as formyloxy, acetoxy, propionyloxy and 2-ethylhexanoyloxy groups,
for the phosphato groups Y: those derived from dimethyl phosphate, diethyl phosphate and dibutyl phosphate groups.

Condensable groups Y which may be mentioned include hydrogen atoms and halogen atoms, preferably chlorine.

The oils (A) are preferably α,ω-dihydroxylated diorganopolysiloxanes of formula (I); in this case Y═OH, n=1 and x is such that the viscosity is between 500 and 500 000 mPas·s at 25° C. and preferably between 800 and 400 000 mPas·s at 25° C.

The majority of these base oils are sold by silicone manufacturers. Moreover, the techniques for manufacturing them are well known; they are described, for example, in French patents FR-A-1 134 005, FR-A-1 198 749 and FR-A-1 226 745.

When, in formula (I), the groups Y are hydroxyl groups, n is then equal to 1 and it is desirable, in order to prepare polyorganosiloxane elastomers from these polymers of formula (I), to use, in addition to the condensation catalysts, crosslinking agents (B) that are silanes of general formula:
R₄₋ₐSiY′ₐ (II)
in which:

R has the meanings given above in formula (I), Y′ represents identical or different hydrolysable or condensable groups and a is equal to 3 or 4.

The examples given for the groups Y are applicable to the groups Y′.

Examples of silanes (B) of formula (II) that may be mentioned more particularly include polyacyloxysilanes, polyalkoxysilanes, polycetiminoxysilanes and polyiminoxysilanes.

The above silanes (B) combined with α,ω-dihydroxylated polydiorganosiloxanes of formula (I) are used in stable two-pack compositions, protected from air.

As examples of silane monomers of formula (II) that, when combined with α,ω-dihydroxylated polydiorganosiloxanes of formula (I), may be used advantageously in two-pack compositions, mention may be made of polyalkoxysilanes.

From 0.1 to 20 parts by weight of crosslinking agent of formula (II) are generally used per 100 parts by weight of polymer of formula (I).

The crosslinking agents (B) of formula (II) are products that are available on the silicones market; furthermore, their use in room-temperature vulcanizable compositions is known; it is featured especially in French patents FR-A-1 126 411, FR-A-1 179 969, FR-A-1 189 216, FR-A-1 198 749, FR-A-1 248 826, FR-A-1 314 649, FR-A-1 423 477, FR-A-1 432 799 and FR-A-2 067 636.

Among the crosslinking agents (B) that are preferred are alkyltrialkoxysilanes, alkyl silicates and polyalkyl silicates, in which the organic radicals are alkyl radicals containing from 1 to 4 carbon atoms.

The polyorganosiloxane compositions that may be crosslinked into elastomer of the type described above may especially comprise from 0.001 to 10 parts by weight and preferably from 0.05 to 3 parts by weight of polycondensation catalyst (C) per 100 parts by weight of polysiloxane of formula (I).

Such a composition is especially room-temperature vulcanizable by using a tin catalyst.

Tin catalysts are abundantly described in the above literature; such a catalyst may in particular be a tin salt of a monocarboxylic or dicarboxylic acid. These tin carboxylates are described especially in the book by Noll (Chemistry and Technology of Silicones, page 337, Academic Press, 1968, 2nd edition). Mention may be made in particular of dibutyltin naphthenate, octanoate, oleate, butyrate or dilaurate, dibutyltin diacetate and dimethyltin didecanoate. The product of reaction of a tin salt, in particular a tin dicarboxylate, with a polyethyl silicate, as described in patent U.S. Pat. No. 3,186,963, may also be used as catalytic tin compound. The product of reaction of a dialkyldialkoxysilane with a tin carboxylate, as described in patent U.S. Pat. No. 3,862,919, may also be used. The product of reaction of an alkyl silicate or of an alkyltrialkoxysilane with dibutyltin diacetate, as described in Belgian patent BE-A-842 305, may also be used. The phenyltrimethoxysilane/dimethyltin didecanoate couple may also be used.

As regards the stabilizer (D) based on pretreated silica, it is used in a proportion of from 10% to 30%, preferably between 15% and 25% and even more preferably between 18% and 22%, by weight relative to the total silicone composition.

According to another noteworthy characteristic, the reinforcing filler (E), when one is used, is chosen from precipitation silicas and combustion silicas.

It especially has a specific surface area, measured according to the BET method, of at least 50 m²/g and preferably greater than 70 m²/g, a mean primary particle size preferably less than 0.1 μm (micrometre) and an apparent density preferably less than 200 g/litre.

These silicas may be incorporated in unmodified form or after having been first treated with organosilicon compounds usually used for this purpose. These silicas may also be incorporated in unmodified form and treated in situ.

The semi-reinforcing fillers (E), when used, have a particle diameter preferably greater than 0.1 μm (micrometre) and are chosen especially from silicas such as, for example, calcined clays and diatomaceous earths.

From 0 to 100 parts and preferably from 5 to 80 parts of filler may generally be used per 100 parts of oil (A).

As additives or adjuvants (F), the composition may comprise at least one additive for providing resistance to the materials to be moulded. This additive is chosen, for example, from:
(1i) phosphites, especially alkyl phosphites, mixed aryl and alkyl phosphites, aryl phosphites and various phosphites;
(2i) sterically hindered phenols, sterically hindered bisphenols and sterically hindered thiobisphenols such as those described especially in EP-A-787 766 and EP-A-854 167;
(3i) aromatic amines especially such as those described in EP-A-787 766;
(4i) hindered amines known as HALS of N—OR, N—R and N—H type (Hindered Amine Light Stabilizers—see Oxidation Inhibition in Organic Materials, Vol. II, Chapter 1: Hindered amines as photostabilizers, Jiri Sedlar). Reference may also be made to EP-A-432 096, EP-A-787 766 and FR-A-773 165. Typical commercial amines are sold under the name Tinuvin® by Ciba Geigy, Novartis or Sankyo.

The silicone composition bases generally defined above are well known to those skilled in the art. They are described in detail in the literature and most are commercially available. These compositions crosslink at room temperature in the presence of moisture provided by the air and/or contained in the composition. They consist essentially of two-pack compositions preferably comprising an α,ω-dihydroxydiorganopolysiloxane oil (A), a silane (B) and a catalyst (C) that is a metallic compound, preferably a tin compound.

Examples of such compositions are described in patents U.S. Pat. No. 3,678,002, U.S. Pat. No. 3,888,815, U.S. Pat. No. 3,933,729, U.S. Pat. No. 4,064,096 and GB-A-2 032 936.

More specifically, such two-pack compositions comprise:
(A): 100 parts of an α,ω-dihydroxydiorganopolysiloxane oil with a viscosity of 50 to 300 000 mPa·s, the organic radicals of which are chosen from methyl, ethyl, vinyl, phenyl and 3,3,3-trifluoropropyl radicals, at least 60% and preferably 80%, in numerical terms, being methyl radicals, up to 20%, in numerical terms, possibly being phenyl radicals, and not more than 2% possibly being vinyl radicals,
(B): from 0.5 to 15 parts of a polyalkoxysilane or polyalkoxysiloxane,
(C): from 0.01 to 1 part (calculated by weight of tin metal) of a catalytic tin compound,
(D): from 10 to 30 parts by weight of a stabilizer based on pretreated silica,
(E): from 0 to 100 parts and preferably from 5 to 80 parts of siliceous mineral reinforcing and/or semi-reinforcing filler,
(F): from 0 to 100 parts and preferably from 5 to 80 parts of additive(s) or adjuvant(s).

The RTV compositions sold by Rhodia Silicones under the brand names Rhodorsil® RTV 585 and Rhodorsil® RTV 555, into which the stabilizer (D) is added, are particularly suitable.

The polycondensation compositions may also optionally comprise from 10 to 130 parts by weight of polydimethylsiloxane oil(s) blocked at each of the chain ends with a (CH₃)₃SiO_{0.5} unit, with a viscosity at 25° C. of between 10 and 5 000 mPa·s, per 100 parts of oil(s) (A), as additive(s) or adjuvant(s) (F).

The compositions may also optionally comprise adjuvants that are known per se, to accelerate or decelerate the crosslinking, pigments and/or specific adjuvants.

The compositions according to the invention may be shaped, extruded and in particular moulded on a form whose impression it is desired to be taken, and then room-temperature vulcanized into an elastomer at atmospheric humidity or by addition of water. Gentle heating to a temperature ranging, for example, from 20 to 80° C. may accelerate the vulcanization.

The use of a stabilizer based on pretreated silica as defined above is particularly recommended for stabilizing silicone elastomers for making up moulds for moulding polyester parts, so as to prevent, within the silicone elastomer, the polymerization of the impeding the polymerization at the core and at the surface of the polyester.

Another subject of the invention relates to a process for making moulds, especially moulds for moulding polymer materials, characterized in that it consists in using in the polycondensation-crosslinkable silicone composition, which is the precursor of the elastomer for making up the said mould, a silica pretreated with a silane as an agent for stabilizing the elastomer for making up the mould.

Yet another subject of the present invention relates to moulds as obtained using the above process.

The examples that follow, which are given as non-limiting guides, will allow the invention to be understood more clearly.

### EXAMPLES

### Examples 1 to 3

### Preparation of RTV-2 Polycondensation-Crosslinking Silicone Compositions and Measurement of Their Mechanical and Theological Properties

1) Base Silicone Composition:

The RTV used is a two-pack product or RTV-2, namely Rhodorsil® RTV 585, sold by Rhodia Silicones, to which is added the stabilizing additive based on 2) Stabilizing Additives used in the RTV-2 Composition:

Various stabilizing additives consisting of various types of pretreated quartz were used in the RTV-2 silicone composition and tested in order to evaluate their capacity to improve the mechanical properties of this composition. These pretreated quartzes are collated in Table 1 below. These additives are distributed by the company Sibelco Belgique.

TABLE 1

| | | | | Mean particle |
|---|---|---|---|---|
| | Additive | Treatment | Treating agent | size (D50), μm |
| Control | E-600 | no | — | 2 |
| Example 1 | TST-8000 | yes | methylsilane | 3 |
| Example 2 | TST-600 | yes | methylsilane | 4 |
| Example 3 | TST-600 | yes | trimethylsilane | 4 |

3) Measurement of the Rheological and Mechanical Properties of Compositions Comprising Various Additives:

Table 2 below collates the rheological and mechanical properties measured after 24 hours, and also the compositions of the various test compositions.

The measurements of the Theological and mechanical properties are performed according to the following standards:
Viscosity measurement: NF T 76 102
Measurement of the techné gel time: NF T 77 107
Shore A hardness: DIN 53505 and ISO 868
Type A tear strength: ASTM 624 A
Type C tear strength: ASTM 624 C

Breaking strength and elongation at break: NF T 46 002

TABLE 2

| | Control 1 | Example 1 | Example 2 | Example 3 |
|---|---|---|---|---|
| | Samples | | | |
| | | | | RTV |
| | RTV 585 + | RTV 585 + | RTV 585 + | 585 + |
| | E-600 | TST-8000 | TST-600 | RST-600 |
| | (18%) | (18%) | (18%) | (18%) |
| Viscosity, mPa · s | 34,000 | 55,400 | 33,000 | 33,000 |
| Viscosity after | 39,800 | 462,400 | 36,000 | 38,000 |
| ageing, mPa · s | | | | |
| Gel time, min | 28 | 36 | 28 | 28 |

Mechanical properties after 24 hours

| | | | | |
|---|---|---|---|---|
| Shore A hardness | 20 | 22.8 | 19.9 | 19.9 |
| Tear strength | 18.4 | 28.1 | 20.3 | 17 |
| sample A, N/mm | | | | |
| Tear strength | 16.8 | 20.2 | 18.5 | 19.8 |
| sample C, N/mm | | | | |

It is seen from the results that the best mechanical and rheological properties are obtained for the RTV composition comprising an additive based on quartz treated with methylsilane and whose particles have a mean size of 3 μm (TST-8000).

### Example 4

### Measurement of the Resistance of the Silicone Composition RTV-585 Comprising Various Amounts Of Additive Based on Treated Quartz

An RTV-2 silicone compositon equivalent to that described in the preceding examples is prepared with various amounts of additive TST-8000. As in the preceding example, the rheological and mechanical properties are measured after 24 hours. The results are collated in Table 3:

TABLE 3

| | Control 2 | Example 1 | Example 4 |
|---|---|---|---|
| | Sample | | |
| | | RTV 585 + | RTV 585 + |
| | RTV 585 | TST-8000 (18%) | TST-8000 (9%) |
| Viscosity, mPa · s | 40,000 | 55,400 | 53,400 |
| Viscosity after | 60,000 | 462,400 | 141,600 |
| ageing, mPa · s | | | |
| Gel time, min | 40 | 36 | 36 |

Mechanical properties after 24 hours

| | | | |
|---|---|---|---|
| Shore A hardness | 22.0 | 22.8 | 21.8 |
| Tear strength | 23.1 | 28.1 | 25.4 |
| sample A, N/mm | | | |
| Tear strength | 20.1 | 20.2 | 22.5 |
| sample C, N/mm | | | |

Tests for Resistance to Polyester Resins:

The evaluation of the RTV-2 compositions with respect to polyester resins was performed according to the following protocol:

Two films of RTV-2 silicone composition 2 mm thick were prepared.

The mechanical properties were measured on the first film after crosslinking for 24 hours. Test samples (tear strength and elongation at break) are cut out of the second film.

These samples are immersed for 7 hours in a bath of styrene (unsaturated polyester resin 2126AP).

They are next dried and then used for the mechanical property measurements.

The results are collated in Table 4 below:

TABLE 4

| | Control 2 | Example 1 | Example 4 |
|---|---|---|---|
| | Sample | | |
| | | RTV 585 + | RTV 585 + |
| | RTV 585 | TST-8000 (18%) | TST-8000 (9%) |
| Shore A hardness | 22.0 | 22.8 | 21.8 |
| (before immersion) | | | |
| Shore A hardness | 22.1 | 22.5 | 21.0 |
| (after immersion) | | | |
| Tear strength, sample | 24.8 | 28.1 | 25.4 |
| A (before immersion) | | | |
| Tear strength, sample | 4.2 | 15.0 | 11.2 |
| A (after immersion) | | | |
| Tear strength, sample | 20.2 | 20.2 | 22.5 |
| C (before immersion) | | | |
| Tear strength, sample | 5.2 | 8.8 | 12.9 |
| C (after immersion) | | | |
| Breaking strength, mPa | 4.3 | 4.4 | 4.4 |
| (before immersion) | | | |
| Breaking strength, mPa | 2.7 | 3.6 | 3.8 |
| (after immersion) | | | |
| Elongation, % (before | 420 | 412 | 423 |
| immersion) | | | |
| Elongation, % (after | 332 | 318 | 330 |
| immersion) | | | |

It is seen from the results that the use of the addition based on preheated quartz in the RTV-2 silicone composition makes it possible to conserve better mechanical properties after contact with the polyester resin and thus makes it possible to improve the resistance of the composition to this resin used for moulding.

During a second test, the various additives used in Examples 1 to 3 were compared as regards their resistance to moulding compositions, under the same experimental conditions. The results are collated in Table 5 below:

TABLE 5

| | Control 2 | Example 1 | Example 2 | Example 3 |
|---|---|---|---|---|
| | Sample | | | |
| | | RTV | RTV | RTV |
| | | 585 + | 585 + | 585 + |
| | | TST-8000 | TST-600 | RST-600 |
| | RTV 585 | (18%) | (18%) | (18%) |
| Shore A hardness | 22.0 | 22.8 | 22.5 | 23.3 |
| (before immersion) | | | | |
| Shore A hardness (after | 22.1 | 22.5 | 22.4 | 23.0 |
| immersion) | | | | |
| Tear strength, sample A | 24.8 | 28.1 | 20.3 | 17.0 |
| (before immersion) | | | | |
| Tear strength, sample A | 4.2 | 15.0 | 5.2 | 3.5 |
| (after immersion) | | | | |
| Tear strength, sample C | 20.2 | 20.2 | 18.5 | 19.8 |
| (before immersion) | | | | |
| Tear strength, sample C | 5.2 | 8.8 | 4.5 | 4.6 |
| (after immersion) | | | | |
| Breaking strength, mPa | 4.3 | 4.4 | 4.2 | 4.1 |
| (before immersion) | | | | |
| Breaking strength, mPa | 2.7 | 3.6 | 3.3 | 3.0 |
| (after immersion) | | | | |
| Elongation, % (before | 420 | 412 | 435 | 383 |
| immersion) | | | | |
| Elongation, % (after | 332 | 318 | 326 | 310 |
| immersion) | | | | |

It is found, entirely surprisingly, that not only does the conservation of the mechanical properties after contact with a moulding composition vary as a function of the additive-treating agent, but also, for the same treating agent, the mechanical properties of the RTV-2 silicone composition are more or less conserved depending on the particle size of the additive. Thus, it is observed that, in accordance with the results obtained in Examples 1 to 3, it is the RTV-2 silicone composition containing the additive TST-8000 that shows the best resistance to the unsaturated polyester resin 2126AP, used for the test.

### Examples 5-6

### Measurement of the Resistance of the RTV-555 Silicone Composition Comprising Various Amounts of Additive Based on Treated Quartz

In order to confirm these results, the measurements taken in Example 4 were reproduced with the silicone composition Rhodorsil® RTV-555.

TABLE 6

| | Control 3 | Example 5 | Example 6 |
|---|---|---|---|
| | Sample | | |
| | | RTV 555 + | RTV 555 + |
| | RTV 555 | TST-8000 (22.1%) | RST-8000 (11.1%) |
| Viscosity, mPa · s | 66,200 | 78,000 | 70,200 |
| Viscosity after | 91,000 | 508,000 | 258,400 |
| ageing, mPa · s | | | |
| Gel time, min | 15 | 17 | 22 |

Mechanical properties after 24 hours

| | | | |
|---|---|---|---|
| Shore A hardness | 20.4 | 21.8 | 21.0 |
| Tear strength | 21.9 | 25.6 | 27.3 |
| sample A, N/mm | | | |
| Tear strength | 19.4 | 22.8 | 20.5 |
| sample C, N/mm | | | |

TABLE 7

| | Control 3 | Example 5 | Example 6 |
|---|---|---|---|
| Shore A hardness | 20.4 | 21.8 | 21.0 |
| (before immersion) | | | |
| Shore A hardness | 20.0 | 21.3 | 21.0 |
| (after immersion) | | | |
| Tear strength, sample | 21.9 | 25.6 | 27.3 |
| A (before immersion) | | | |
| Tear strength, sample | 4.8 | 16.7 | 10.1 |
| A (after immersion) | | | |
| Tear strength, sample | 19.4 | 22.8 | 20.5 |
| C (before immersion) | | | |
| Tear strength, sample | 4.0 | 12.0 | 5.2 |
| C (after immersion) | | | |
| Breaking strength, mPa | 3.4 | 3.6 | 3.6 |
| (before immersion) | | | |
| Breaking strength, mPa | 2.7 | 3.2 | 2.8 |
| (after immersion) | | | |
| Elongation, % (before | 474 | 452 | 493 |
| immersion) | | | |
| Elongation, % (after | 258 | 328 | 310 |
| immersion) | | | |

In accordance with the results obtained in Example 4, it is found that the use of the additive TST-8000 makes it possible to greatly reduce the impact of moulding compositions and especially of polyesters on the RTV-2 silicone composition.

1-15. (canceled)

16. A polycondensation-crosslinkable silicone composition having particulates of a silane-pretreated silica distributed therethrough, said silane-pretreated silica being present in such amount as to stabilize an elastomeric polymerizate prepared from said polycondensation-crosslinkable silicone composition.

17. The polycondensation-crosslinkable silicone composition as defined by claim 16, said silica particulates comprising ground quartz.

18. The polycondensation-crosslinkable silicone composition as defined by claim 16, said silane having the general formula (I):
SiR¹ₐR²_{b} (I)
in which R¹ is, independently, a C₁-C₆ saturated or unsaturated alkoxy radical or a C₁-C₆ saturated or unsaturated alkyl radical; R² is, independently, a hydrogen atom or a chlorine atom; a and b range from 0 to 4; and a+b is equal to 4.

19. The polycondensation-crosslinkable silicone composition as defined by claim 16, said polycondensation-crosslinkable silicone composition comprising:
(A) at least one diorganopolysiloxane oil bearing at each end of the polymer chain at least two condensable or hydrolyzable groups, or a single hydroxyl group;
(B) optionally, at least one silane comprising at least three condensable or hydrolyzable groups, when (A) is an oil containing hydroxyl end groups;
(C) a catalytically effective amount of a polycondensation catalyst; and
(D) an effective amount of at least one stabilizer.

20. The polycondensation-crosslinkable silicone composition as defined by claim 16, further comprising:
(E) a reinforcing and/or semi-reinforcing filler; and/or
(F) at least one other additive or adjuvant.

21. The polycondensation-crosslinkable silicone composition as defined by claim 17, the ground quartz having been treated with an alkylsilane.

22. The polycondensation-crosslinkable silicone composition as defined by claim 21, the ground quartz treated with an alkylsilane comprising particulates having a mean particle size of 3 μm.

23. The polycondensation-crosslinkable silicone composition as defined by claim 20, comprising a reinforcing filler (E) selected from the group consisting of a precipitation silica and a combustion silica.

24. The polycondensation-crosslinkable silicone composition as defined by claim 20, comprising a semi-reinforcing filler (E) which comprises a silica selected from the group consisting of calcined clays and diatomaceous earths.

25. The polycondensation-crosslinkable silicone composition as defined by claim 17, said pretreated ground quartz comprising from 10% to 30% by weight thereof.

26. The polycondensation-crosslinkable silicone composition as defined by claim 20, comprising an additive or adjuvant (F) for providing resistance to materials molded from elastomeric molds shaped therefrom.

27. The polycondensation-crosslinkable silicone composition as defined by claim 26, said additive or adjuvant (F) being selected from the group consisting of:
(1 i) phosphites, alkyl phosphites, mixed aryl and alkyl phosphites, and aryl phosphites;
(2i) sterically hindered phenols, sterically hindered bisphenols and sterically hindered thiobisphenols;
(3i) aromatic amines;
(4i) the hindered amines HALS of N—OR, N—R and N—H.

28. A process for stabilizing a silicone elastomer mold shaped from a polymerizate of a polycondensation-crosslinkable silicone, comprising including within said polycondensation-crosslinkable silicone an amount of particulates of a silane-pretreated silica such that the polymerization of (co)monomers therein will proceed at both the core and surface thereof.

29. A mold member shaped from the elastomeric polymerizate of the polycondensation-crosslinkable silicone composition as defined by claim 16.

30. The polycondensation-crosslinkable silicone composition as defined by claim 18, wherein formula (I), R¹ is, independently, a C₁-C₄ saturated or unsaturated alkoxy radical or a C₁-C₄ saturated or unsaturated alkyl radical.

31. The polycondensation-crosslinkable silicone composition as defined by claim 25, said pretreated ground quartz comprising from 15% to 25% by weight thereof.

32. The polycondensation-crosslinkable silicone composition as defined by claim 31, said pretreated ground quartz comprising from 18% to 22% by weight thereof.

33. The polycondensation-crosslinkable silicone composition as defined by claim 16, comprising an RTV polyorganosiloxane.

34. A shaped polyester resin polymerized within the mold member as defined by claim 29.

35. The polycondensation-crosslinkable silicone composition as defined by claim 33, comprising an RTV-2 polyorganosiloxane.
